(19) United States
(12) Patent Application Publication
(10) Pub. No.: US 2024/0149129 A1
(43) Pub. Date: May 9, 2024

(54) LAUNCH WHEEL FOR A BALL-THROWING MACHINE

(71) Applicant: TOCA Football, Inc., Costa Mesa, CA (US)

(72) Inventors: Wayne Morton Rapp, Irvine, CA (US); James Lawrence LaBelle, Murrieta, CA (US)

(21) Appl. No.: 18/500,904

(22) Filed: Nov. 2, 2023

Related U.S. Application Data
(60) Provisional application No. 63/422,370, filed on Nov. 3, 2022.

(51) Int. Cl. A63B 69/40

(52) U.S. Cl. CPC A63B 69/406; A63B 2069/402; A63B 2225/50; A63B 2243/0025

(57) ABSTRACT

A launch wheel of a ball-throwing machine including a coupling insert that includes one or more coupling mechanisms configured to clamp onto a motor shaft. Deflectable arms of the coupling mechanism are drawn together via a screw extending along a chord of the coupling insert. A manufacturing process of the wheel frame includes over-molding a wheel frame onto the coupling insert. End portions of the coupling insert extend beyond a hub of the wheel frame and include a smooth surface configured define a shut-off interfaces with an injection mold for the wheel frame. Each smooth surface extends inward from its respective end of the coupling insert beyond a corresponding coupling mechanism. A centralized knurled portion of an outside circumferential surface ensures secure attachment of the coupling insert with the wheel frame resulting from the over-molding process. Lateral and longitudinal slits extending partially through the coupling insert define the deflectable arms.

### PRIORITY

This application claims priority to U.S. Provisional Patent Application No. 63/422,370, filed Nov. 3, 2022, entitled “MODEL 2100 TOUCH TRAINER,” which is incorporated by reference in its entirety into this application.

### BACKGROUND

In soccer, to be in control of the ball is of importance to every level of player. The ability to control an awkward bouncing ball quickly and effectively gives the player with the ball the immediate advantage. A first touch of the ball is often the difference between success and failure in most situations during the match. Additionally, accuracy in passing and shooting a ball is essential in developing a well-rounded game. A ball-throwing machine can enhance the speed and efficiency of a training program and therefore, improve a player's ability to perform at a high level at a faster rate. Interruptions of the training program, including loss of operation of the ball-throwing machine, can negatively affect the player's training. As such, improvements in reliability and consistency of the ball-throwing process can benefit the player and the training program. In some instances, launch wheels of the ball-throwing machine can wear out causing poor or inaccurate launching of the balls. As such, it would be advantageous for the launch wheels to be easily replaceable by the user. In some instances, a coupling mechanism of a launch wheel may cause damage to a motor shaft making replacement difficult. As such, there is a need for a launch wheel to have a coupling mechanism that provides for easy replacement and does not damage the motor shaft.

Disclosed herein are devices and methods for improving the replaceability of a launch wheel of the ball-throwing machine.

### SUMMARY

Disclosed herein is a coupling insert for securing a launch wheel to an object-throwing apparatus that, according to some embodiments, includes a circumferential wall defining a cylinder having a center hole extending between a first end and a second end of the coupling insert, where the center hole is configured to receive a first portion of a motor shaft therethrough. A coupling surface extends partially along an outside surface of the circumferential wall, where the coupling surface is configured to enable a secure attachment of a wheel frame of the launch wheel to the coupling insert during a forming process of the wheel frame. A first coupling mechanism is disposed at the first end of the coupling insert, where the first coupling mechanism is configured to secure the coupling insert to the first portion of the motor shaft, thereby ensuring co-rotation of the coupling insert and the motor shaft. The first coupling mechanism includes a first screw disposed within a first screw hole, where the first screw hole extends laterally through the cylinder along a first chord of the cylinder, and where the first screw is configured to secure the coupling insert to the first portion of the motor shaft upon tightening of the first screw.

In some embodiments, the first coupling mechanism further includes a shoulder contact surface configured to butt up against a shoulder of the motor shaft when the coupling insert is secured to the motor shaft, where the shoulder is disposed between the first portion and a second portion of the motor shaft, and where the second portion includes a diameter greater than a diameter of the first portion.

In some embodiments, the coupling surface includes a knurling, and in some embodiments, the coupling surface is centrally located between the first end and the second end.

In some embodiments, the coupling insert further includes a first smooth portion extending along the outside surface of the circumferential wall between the first end and the coupling surface, where the first smooth portion extends inward from the first end beyond the first coupling mechanism, and where the first smooth portion is configured to define a first shut-off interface with an injection mold used to form the wheel frame.

In some embodiments, the first coupling mechanism further includes a first lateral slit extending radially inward through the circumferential wall and a first longitudinal slit extending through the circumferential wall between the first end and the first lateral slit. The first lateral slit and the first longitudinal slit define a first deflectable arm and a second deflectable arm, and the first screw hole extends through the first and second deflectable arms.

In some embodiments, the coupling insert further includes a second coupling mechanism disposed at the second end, where the second coupling mechanism is configured to further secure the coupling insert to the first portion of the motor shaft. The second coupling mechanism includes a second screw disposed within a second screw hole, where the second screw hole extends laterally through the cylinder along a second chord of the cylinder, and the second screw is configured to further secure the coupling insert to the first portion of the motor shaft upon tightening of the second screw.

In some embodiments, the coupling insert further includes a second smooth portion extending along the outside surface of the circumferential wall between the second end and the coupling surface, where the second smooth portion extends inward from the second end beyond the second coupling mechanism, and where the second smooth portion is configured to define a second shut-off interface with the injection mold.

In some embodiments, the second coupling mechanism further includes a second lateral slit extending radially inward through the circumferential wall and a second longitudinal slit extending through the circumferential wall between the second end and the second lateral slit. The second lateral slit and the second longitudinal slit define a third deflectable arm and a fourth deflectable arm, and the second screw hole extends through the third and fourth deflectable arms.

Also disclosed herein is a launch wheel for an object-throwing apparatus that, according to some embodiments, includes a wheel frame and a tire coupled with the wheel frame along an outside circumferential frame surface of the wheel frame. A coupling insert is coupled with the wheel frame at center of the wheel frame. The coupling insert includes (i) a circumferential wall defining a cylinder having a center hole extending between a first end and a second end of the coupling insert, where the center hole is configured to receive a first portion of a motor shaft therethrough; (ii) a coupling surface extending partially along an outside surface of the circumferential wall, where the coupling surface is configured to enable a secure attachment of the wheel frame to the coupling insert during a forming process of the wheel frame; and (iii) a first coupling mechanism disposed at the first end, where the first coupling mechanism is configured to secure the coupling insert to the first portion of the motor shaft, thereby ensuring co-rotation of the coupling insert and the motor shaft. The first coupling mechanism includes a first screw disposed within a first screw hole, where the first screw hole extends laterally through the cylinder along a first chord of the cylinder, and where the first screw is configured to secure the coupling insert to the first portion of the motor shaft upon tightening of the first screw. In some embodiments, the wheel frame is formed via a plastic injection molding process.

In some embodiments of the launch wheel, the first coupling mechanism further includes a shoulder contact surface configured to butt up against a shoulder of the motor shaft when the coupling insert is secured to the motor shaft, where the shoulder is disposed between the first portion and a second portion of the motor shaft, and where the second portion includes a diameter greater than a diameter of the first portion.

In some embodiments of the launch wheel, the coupling surface includes a knurling, and in some embodiments, the coupling surface is centrally located between the first end and the second end.

In some embodiments, the launch wheel further includes a first smooth portion extending along the outside surface of the circumferential wall between the first end and the coupling surface, where first smooth portion extends inward from the first end beyond the first coupling mechanism, and where the first smooth portion is configured to define a first shut-off interface with an injection mold used to form the wheel frame.

In some embodiments, the first coupling mechanism further includes a first lateral slit extending radially inward through the circumferential wall and a first longitudinal slit extending through the circumferential wall between the first end and the first lateral slit. The first lateral slit and the first longitudinal slit define a first deflectable arm and a second deflectable arm, and the first screw hole extends through the first and second deflectable arms.

In some embodiments of the launch wheel, the coupling insert further includes a second coupling mechanism disposed at the second end, where the second coupling mechanism configured to further secure the coupling insert to the first portion of the motor shaft. The second coupling mechanism includes a second screw disposed within a second screw hole, the second screw hole extends laterally through the cylinder along a second chord of the cylinder, and the second screw is configured to further secure the coupling insert to the first portion of the motor shaft upon tightening of the second screw.

In some embodiments of the launch wheel, the coupling insert further includes a second smooth portion extending along the outside surface of the circumferential wall between the second end and the coupling surface, where the second smooth portion extends inward from the second end beyond the second coupling mechanism, and where the second smooth portion is configured to define a second shut-off interface with the injection mold.

In some embodiments of the launch wheel, the second coupling mechanism further includes a second lateral slit extending radially inward through the circumferential wall and a second longitudinal slit extending through the circumferential wall between the second end and the second lateral slit. The second lateral slit and the second longitudinal slit define a third deflectable arm and a fourth deflectable arm, and the second screw hole extends through the third and fourth deflectable arms.

Also disclosed herein is a method of manufacturing a launch wheel for an object-throwing apparatus that, according to some embodiments, includes placing a coupling insert within a plastic injection mold. The coupling insert includes (i) a circumferential wall defining a cylinder having a center hole extending between a first end and a second end of the coupling insert, where a coupling surface of the including a knurling extends partially along an outside surface of the circumferential wall; (ii) a first coupling mechanism disposed at the first end, where the first coupling mechanism is configured to secure the coupling insert to a motor shaft; (iii) a first smooth portion of the outside surface extending inward from the first end beyond the first coupling mechanism, where the first smooth portion is configured to define a first shut-off interface with the plastic injection mold; (iv) a second coupling mechanism disposed at the second end, where the second coupling mechanism is configured to further secure the coupling insert to the motor shaft; and (v) a second smooth portion of the outside surface extending inward from the second end beyond the second coupling mechanism, where the second smooth portion is configured to define a second shut-off interface with the plastic injection mold. The manufacturing method further includes (i) injecting a plastic material into the plastic injection mold to form a wheel frame of the launch wheel, where the wheel frame includes an outside circumferential frame surface; and (ii) attaching a tire to the outside circumferential frame surface, where the tire includes an elastomeric material.

In some embodiments of the manufacturing method, attaching the tire to the outside circumferential frame surface includes over-molding the elastomeric material onto the outside circumferential frame surface.

In some embodiments, the manufacturing method further includes (i) threadably inserting a first screw within a first screw hole of the first coupling mechanism, where the first screw hole extends along a first chord of the coupling insert; and (ii) threadably inserting a second screw within a second screw hole of the second coupling mechanism, where the second screw hole extends along a second chord of the coupling insert.

Also disclosed herein is a method of installing a launch wheel onto a motor shaft of an object-throwing apparatus that, according to some embodiments, includes (i) longitudinally sliding the launch wheel onto the motor shaft, where the motor shaft is disposed within a center hole of a coupling insert of the launch wheel; (ii) butting a shoulder contact surface of the coupling insert up against a shoulder surface of the motor shaft, thereby defining a location of the launch wheel with respect to a ball-delivery ramp of the object-throwing apparatus; and (iii) tightening a first screw of a first coupling mechanism of the coupling insert to secure the coupling insert to the motor shaft, where the first screw extends along a first chord of the coupling insert.

In some embodiments of the installation method, the first coupling mechanism is disposed adjacent the shoulder contact surface.

In some embodiments, the installation method further includes tightening a second screw of a second coupling mechanism of the coupling insert to further secure the coupling insert to the motor shaft, where the second screw extends along a second chord of the coupling insert.

In some embodiments of the installation method, the second coupling mechanism is disposed on a side of the launch wheel opposite the shoulder contact surface.

In some embodiments of the installation method, the coupling insert includes a smooth outside circumferential surface extending longitudinally inward of the shoulder contact surface beyond the first coupling mechanism, where the smooth outside circumferential surface is configured to define a shut-off interface with a plastic injection mold used to form a wheel frame of the launch wheel.

These and other features of the concepts provided herein will become more apparent to those of skill in the art in view of the accompanying drawings and following description, which describe particular embodiments of such concepts in greater detail.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 is a perspective front view illustration of a ball-throwing machine according to some embodiments.

FIG. 2 is a cross-section side view of the ball-throwing machine of FIG. 1 according to some embodiments.

FIG. 3 is a top view of a control unit of the ball-throwing machine of FIG. 1 according to some embodiments.

FIG. 4 is block diagram of a first computerized method of the ball-throwing machine of FIG. 1 according to some embodiments.

FIG. 5A is block diagram of a second computerized method of the ball-throwing machine of FIG. 1 according to some embodiments.

FIG. 5B is block diagram of a third computerized method of the ball-throwing machine of FIG. 1 according to some embodiments.

FIG. 6A is a front view of the ball-throwing machine of FIG. 1 with the ball hopper removed according to some embodiments.

FIG. 6B is a detailed view of a portion of the ball-throwing machine of FIG. 1 showing the ball sensor and the ball stop according to some embodiments.

FIG. 7A is a side view illustration of motor-wheel assembly of the ball-throwing machine of FIG. 1 according to some embodiments.

FIG. 7B is a side view illustration of motor-wheel assembly of FIG. 7A in an exploded state according to some embodiments.

FIG. 8A illustrates an end view of a wheel assembly of the launch wheel of FIGS. 7A, 7B according to some embodiments.

FIG. 8B is a cross-sectional top view of the wheel assembly of FIG. 8A cut along sectioning lines 8B-8B according to some embodiments.

FIG. 8C is a cross-sectional side view of the wheel assembly of FIG. 8A cut along sectioning lines 8C-8C according to some embodiments.

FIG. 9A is a perspective view of a coupling insert of the wheel assembly of FIGS. 8A-8C according to some embodiments.

FIG. 9B is an end view of the coupling insert of FIG. 9A according to some embodiments.

FIG. 9C is a top view of the coupling insert of FIG. 9A according to some embodiments.

FIG. 9D is a front view of the coupling insert of FIG. 9A according to some embodiments.

FIG. 10 is a block diagram of a method of manufacturing the wheel assembly of FIGS. 8A-8C according to some embodiments.

FIG. 11 is a block diagram of a method of installing the launch wheel onto the motor shaft of FIGS. 7A, 7B according to some embodiments.

### DETAILED DESCRIPTION

Before some particular embodiments are disclosed in greater detail, it should be understood that the particular embodiments disclosed herein do not limit the scope of the concepts provided herein. It should also be understood that a particular embodiment disclosed herein can have features that can be readily separated from the particular embodiment and optionally combined with or substituted for features of any of a number of other embodiments disclosed herein.

Regarding terms used herein, it should also be understood the terms are for the purpose of describing some particular embodiments, and the terms do not limit the scope of the concepts provided herein. Ordinal numbers (e.g., first, second, third, etc.) are generally used to distinguish or identify different features or steps in a group of features or steps, and do not supply a serial or numerical limitation. For example, “first,” “second,” and “third” features or steps need not necessarily appear in that order, and the particular embodiments including such features or steps need not necessarily be limited to the three features or steps. Labels such as “left,” “right,” “top,” “bottom,” “front,” “back,” and the like are used for convenience and are not intended to imply, for example, any particular fixed location, orientation, or direction. Instead, such labels are used to reflect, for example, relative location, orientation, or directions. Singular forms of “a,” “an,” and “the” include plural references unless the context clearly dictates otherwise.

The phrases “connected to,” “coupled with,” and “in communication with” refer to any form of interaction between two or more entities, including but not limited to mechanical, electrical, magnetic, electromagnetic, fluid, and thermal interaction. Two components may be coupled with each other even though they are not in direct contact with each other. For example, two components may be coupled with each other through an intermediate component.

The term “logic” may be representative of hardware, firmware or software that is configured to perform one or more functions. As hardware, the term logic may refer to or include circuitry having data processing and/or storage functionality. Examples of such circuitry may include, but are not limited or restricted to a hardware processor (e.g., microprocessor, one or more processor cores, a digital signal processor, a programmable gate array, a microcontroller, an application specific integrated circuit “ASIC”, etc.), a semiconductor memory, or combinatorial elements.

Additionally, or in the alternative, the term logic may refer to or include software such as one or more processes, one or more instances, Application Programming Interface(s) (API), subroutine(s), function(s), applet(s), servlet(s), routine(s), source code, object code, shared library/dynamic link library (dll), or even one or more instructions. This software may be stored in any type of a suitable non-transitory storage medium, or transitory storage medium (e.g., electrical, optical, acoustical or other form of propagated signals such as carrier waves, infrared signals, or digital signals). Examples of a non-transitory storage medium may include, but are not limited or restricted to a programmable circuit; non-persistent storage such as volatile memory (e.g., any type of random access memory “RAM”); or persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the logic may be stored in persistent storage.

Unless defined otherwise, all technical and scientific terms used herein have the same meaning as commonly understood by those of ordinary skill in the art. As used herein, the word “trajectory” includes the initial path of an object upon launch, where the initial path includes a launch angle with respect to the ground and a lateral or side-by-side direction.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method. Additionally, all embodiments disclosed herein are combinable and/or interchangeable unless stated otherwise or such combination or interchange would be contrary to the stated operability of either embodiment.

A soccer player's first touch of the ball is an important core skill to develop. A touch can be as simple as receiving a slow pass on the ground or as difficult as taking a top speed knuckling ball out of the air and straight down onto one's foot. First touch development is a continual process; youth and professionals alike perpetually train to ever improve their first touch and ball handling skills. The skill of touch is typically trained by players forming pairs and passing the ball to one another. This training method can produce results but tends to fall short in providing a disciplined approach to training that enables progress measurement and goal-oriented improvement. Further, this technique requires a player to find another individual with which to practice, which is not always practical, particularly for serious athletes who devote significant time to their training.

This disclosure describes a specialized ball-throwing machine that can be used to improve a player's first touch and ball control, among other benefits. The ball-throwing machine can be designed to throw, lob, pitch, or otherwise eject soccer balls toward a player, who can trap the balls or practice other ball control skills. The ball-throwing machine may be controlled using a controller in the form of a handheld computing device or the like. The game of soccer is commonly known in some countries as “football” or “association football.” For convenience, this specification refers solely to the term “soccer,” although such usage should be considered synonymous with “football” and “association football.” Further, embodiments of the ball-throwing machine, controller, and soccer network application described herein can be used or adapted for sports other than soccer, some examples of which are described below.

It should also be noted that although this specification refers primarily to using a ball-throwing machine to train ball trapping skills, the ball-throwing machine can be used to train other skills. For example, the ball-throwing machine can be used to train passing, shooting, and stopping a soccer ball, among other ball skills. Note that further details regarding the ball-throwing machine can be found in U.S. Pat. Nos. 9,010,309, 9,555,306 and 10,252,128, and 10,118,078 each of which is incorporated by reference in its entirety into this application.

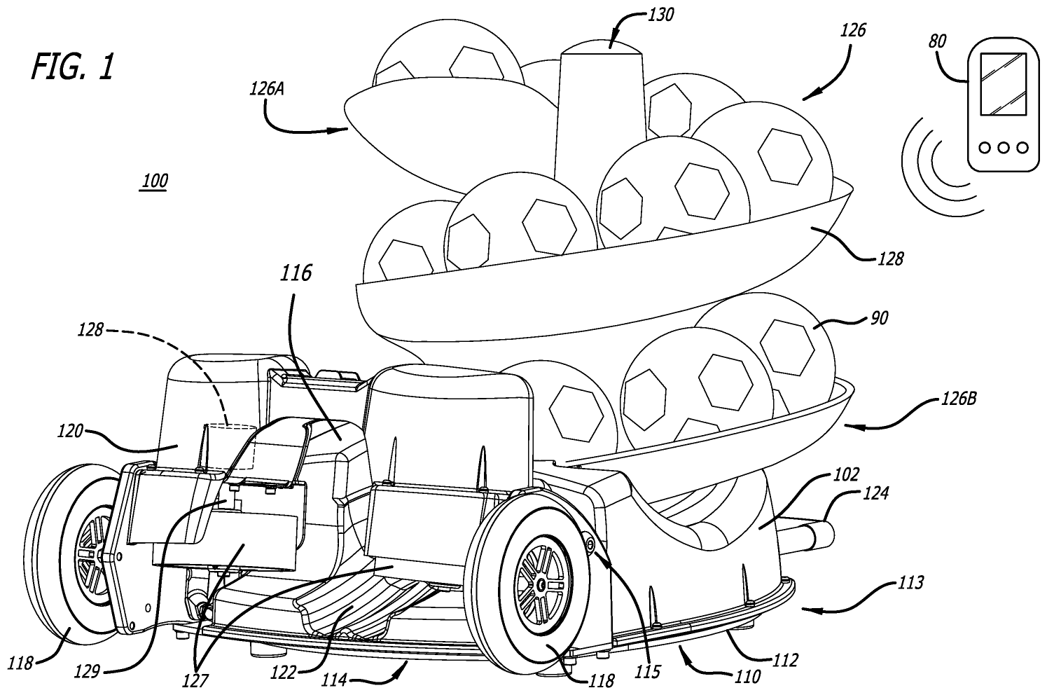

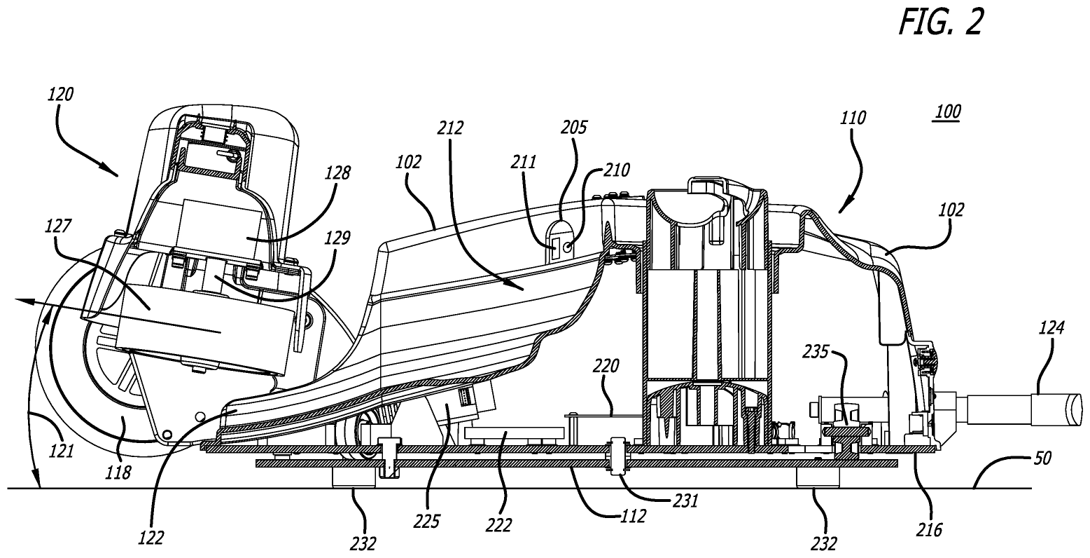

FIG. 1 illustrates a perspective view of a ball-throwing machine 100 (sometimes referred to as an object-throwing apparatus) according to some embodiments, and FIG. 2 is a cross-sectional side view of the ball-throwing machine 100 showing various internal components, where the ball-throwing machine 100 is placed on the ground 50. The ball-throwing machine 100 can be used to pitch a ball, such as to deliver a ball to a user. For example, the ball-throwing machine 100 can be used to deliver a soccer ball or a specialized soccer-type ball to a user. The ball-throwing machine 100 can also be used with various other balls or objects for various other sports, including traditional sport balls having varying sizes such as soccer balls of sizes “1,” “2,” “3,” “4,” or “5,” for example as noted below.

A remote controller 80 is shown in wireless communication with the ball-throwing machine 100. The remote controller 80 can be a computing device of the player/user, and may be, for example, a smart phone, tablet, laptop, personal digital assistant (PDA), or other wireless handheld device, or even a desktop in some embodiments. The remote controller 80 can communicate wirelessly with a wireless module in the ball-throwing machine 100. The remote controller 80 can include functionality for controlling the training programs that run on the ball-throwing machine 100. For example, the remote controller 80 can include functionality for a user to select training programs to be communicated to the ball-throwing machine 100. Each training program can include a set of drills, commands, or instructions to be executed by the ball-throwing machine 100, such as how many balls to throw in a given period of time, how fast, and with what trajectory. The training programs can be selected and customized by the user. In some embodiments, the remote controller 80 may be a network device such as a mobile phone/device or tablet that is communicatively coupled to the ball-throwing machine 100 directly through a wireless protocol (e.g., the BLUETOOTH® standard) and/or indirectly through logic processing on remote computing resources, which may be a local server device or cloud-computing resources.

The illustrated ball-throwing machine 100 includes a housing 102. The ball-throwing machine 100 can be easily movable. For example, the ball-throwing machine can include one or more transport wheels 118, which in some embodiments may be motorized. The ball-throwing machine 100 may also include one or more handles 124 for grasping and manipulating the ball-throwing machine 100 while moving the same. In some embodiments, the one or more handles 124 may be extendable and/or positionable.

With reference to FIGS. 1 and 2, the ball-throwing machine 100 includes a hopper 126. The hopper 126 can be used to receive and/or store balls 90 to later be ejected or thrown by the ball-throwing machine 100. The illustrated embodiment includes a high-volume or large storage-type hopper 126. In some embodiments, the hopper 126 can store as many as 25 balls 90. Of course, it will be understood that the hopper 126 could hold more or less balls 90, as necessary or desired.

Many different styles and types of hoppers can be used. As shown, the hopper 126 is a gravity-type hopper with a spiraling ramp 128 located around a hopper column 130. The hopper column 130 can be used to impart structural strength to the hopper 126 and can also provide appropriate spacing such that balls 90 within the hopper 126 are able to properly rotate and move downward in the hopper 126. Alternatively, the hopper column 130 is not included in some embodiments. Rather, the hopper 126 merely includes the spiraling ramp 128. In another embodiment, the spiraling ramp 128 is omitted and the hopper 126 includes a column that holds a plurality of balls 90.

In some embodiments, the hopper 126 can be transparent. For example, the outer material of the hopper may be clear PLEXIGLAS® or plastic, or a thin mesh-like fabric. This transparency can allow the user to view the balls 90 in the hopper 126 and identify when the hopper 126 needs to be reloaded. The hopper 126 can have a top hopper portion 126A and a bottom hopper portion 126B. The top hopper portion 126A can be configured for receiving one or more balls 90 into the hopper 126 and in some embodiments, can hold additional balls 90. The bottom hopper portion 126B can be configured to transition the balls 90 from the hopper 126 into a ball staging area 212, sometimes referred to as the base of the hopper 126.

The hopper 126 can be used for storing the balls 90 when the ball-throwing machine 100 is in use and/or when the ball-throwing machine 100 is not in use. In some embodiments, the hopper 126 can be collapsible or detachable to decrease the size of the ball-throwing machine 100, such as when the ball-throwing machine is not in use. In some embodiments, the hopper column 130 can be a telescoping tube and the outer material of the hopper 126 can be fabric, such that the hopper 126 can increase or decrease in size. In some embodiments with the collapsible hopper 126, the top hopper portion 126A can be collapsed to sit on top of the bottom hopper portion 126B. Alternatively, the hopper column 130 can be configured to be removable to remove structural support separating the top hopper portion 126A from the bottom hopper portion 126B.

Advantageously, in certain embodiments, the ball-throwing machine 100 is designed to deliver soccer balls that are smaller than adult regulation size soccer balls to thereby enable more effective training of ball trapping skills. The smaller surface area of such balls can make the smaller balls harder to trap than regulation size balls (such as size “5” soccer balls). Training with smaller balls can therefore benefit a player using a larger, regulation-size ball in a match because the player may have obtained skills that transfer over to the easier-to-trap, larger ball. In some embodiments, the balls used with the ball-throwing machine 100 are about half the size of regulation size 5 balls, about a third of the size of regulation size 5 balls, about a quarter of the size of regulation size 5 balls, or some other size. For youth players who may already be using a smaller ball than an adult ball in matches, the ball-throwing machine 100 can employ even smaller balls than the youth players use in their matches. For instance, if a youth player typically uses size 4 soccer balls, the ball-throwing machine 100 can throw size 3 soccer balls or smaller, etc. However, in other embodiments, regulation size balls are used instead of smaller balls.

The size of the balls 90 used by the ball-throwing machine 100 can be smaller than a regulation size 5 ball, even for older youth and adult players. For example, in one embodiment, the balls are preferably about 152 mm in diameter. However, in other embodiments the balls can range in size from about 132 mm to about 172 mm in diameter while still providing some or all of the benefits of the balls described herein. In still other embodiments, the balls can range in size from about 115 mm to 215 mm in diameter while still providing at least some of the benefits described herein.

The balls 90 that may be used herein may have any of the following characteristics: a rubber construction, a butyl bladder, one or more nylon plys (such as 1, 2, 3, or 4 or more nylon plys), spiral winding of the nylon plys, and the like. These and other characteristics of the balls, among others (including size, texture, weight, cover type, etc.) can be selected to achieve a desired liveliness or bounciness of the ball. Different balls may be provided with different liveliness for different levels of difficulty. For instance, a ball that has more bounce may be harder to trap and thus appropriate for a higher level of difficulty, while a ball with less bounce may be easier to trap and thus appropriate for a lower level of difficulty. Moreover, the colors of the balls can be selected to target foot-eye coordination. For example, the balls may be blue, green, or red, or a combination of the same, as these colors can be the easier to see than other colors. Alternatively, colors may be selected that are less easy to see so as to increase the difficulty of training. Different colors may be provided for players/users, who may perceive colors slightly differently.

In one embodiment, the balls 90 are not actual soccer balls. For example, a ball having a smaller size than a regulation size ball can be considered to be a ball other than a soccer ball. Counterintuitively, it can be beneficial to train soccer skills (such as trapping) using balls that are not soccer balls, such as any of the balls described herein. Balls used in other sports can also be thrown by the ball-throwing machine 100 for the purposes of training soccer skills. Tennis balls, racquet balls, and squash balls, for instance, can be beneficially used to train trapping skills.

The body 110 of the ball-throwing machine 100 includes a back portion 113 and a front portion 114. The back portion 113 includes the ball staging area 212 and the front portion 114 includes the ball-delivery device 120. As can be seen in FIG. 2, the ball staging area 212 is located adjacent a top of a ball-delivery ramp 122, i.e., between the hopper 126 and the ball delivery ramp 122 and the ball staging area 212 can hold one or more balls 90. Shown disposed within an opening 205 of the housing 102, is a ball sensor (or ball-presence sensor) 211 configured to detect when a ball 90 is present within the staging area 212. The ball-throwing machine 100 can also include one or more ball stops configured to selectively prevent and allow individual balls 90 to (i) travel down the ball-delivery ramp 122 to the ball-delivery device 120 or (ii) travel along various stages of the hopper ramp 128. Also shown in FIG. 2, the ball-throwing machine 100 includes a control unit 220 and a power source 222 (e.g., a rechargeable battery) attached to a base frame member (or frame) 216. In the illustrated embodiment, the ball-throwing machine 100 includes a single ball stop 210 shown with the opening 205. In other embodiments, the ball-throwing machine 100 may include more than one ball stop 210.

As is shown, the front portion 114 also includes at least one opening 116. The opening 116 can provide space for the ball 90 to be thrown through to the player. The opening 116 can be one of many different shapes, such as oval, elliptical, rectangular, triangular, or any other desired shape. In some embodiments, an outer housing of the front portion 114 includes a minimal amount of material, such that a majority, or at least a substantial portion, of the ball-delivery device 120 is exposed and not enclosed. In such embodiments, little to no portion of the outer housing may be between the ball-delivery device 120 and the player.

With further reference to FIG. 2, an embodiment of the ball-delivery device 120 is shown. The ball-delivery device 120 can include any number of various components. The ball-delivery device 120 can be used to impart motion to a ball 90. In some embodiments, the ball-delivery device 120 can be used to control (i) a launch angle 121 of the ball 90 with respect to the ground 50 and (ii) a speed of the ball 90 as it leaves the ball-throwing machine 100. The ball-delivery device 120 can perform these functions in various different manners including those described below. It is to be understood that the ball-delivery device 120 also encompasses various other systems and methods of performing the above functions, as well as other, additional and/or alternative functions.

As illustrated, the ball-delivery device 120 includes one or more launch wheels or balls (e.g., the two launch wheels 127) which are used to impart a speed, a spin, and/or a lateral direction to the ball 90 The ball-delivery device 120 can also include one or more motors 128 which are connected to the launch wheels 127 to cause the launch wheels 127 to rotate, which rotation imparts the speed, spin, and/or lateral direction to the ball 90. Each launch wheel 127 is coupled with a launch motor 128 via a shaft. In some instances, the two launch wheels 127 may rotate at the same rate, and in other instances the two launch wheels 127 may rotate at different rates to impart a spin to the ball 90 so as to cause the ball 90 to curve when launched. The launch wheel 127 is attached to that shaft 129 of the motor 128 so that the launch wheel 127 and the shaft 129 co-rotate.

With reference to both FIGS. 1 and 2, the ball-delivery device 120 is rotatably coupled with the base frame member 216 at rotatable coupling points 115. Rotation of the ball-delivery device 120 with respect to the base frame member 216 defines the launch angle 121 of the ball 90. The ball-throwing machine 100 also includes a launch angle actuator 225 coupled between the ball-delivery device 120 and the base frame member 216, where the launch angle actuator 225 is configured to control or adjust an angle of the ball delivery device 120 with respect to the base frame member 216 to define the launch angle 121 of the ball 90 with respect to the ground 50. The launch angle actuator 225 may include a motor of any suitable type, such as a brushed DC motor, a servo motor, or a stepper motor, for example.

The ball-throwing machine 100 includes a base plate 112 rotatably coupled with the base frame member 216 via an axle 231 extending between a base plate 112 and the base frame member 216. The base plate 112 includes a number of feet 232 configured to provide a stable placement of the ball-throwing machine 100 on the ground 50. A lateral direction actuator 235 is coupled between the base plate 112 and the base frame member 216 such that operation of the lateral direction actuator 235 causes the base frame member 216 to rotate with respect to the base plate 112 during use. The rotation of the base frame member 216 with respect to the base plate 112 defines the lateral (side by side) direction of the trajectory. The lateral direction actuator 235 may include a motor of any suitable type, such as a brushed DC motor, a servo motor, or a stepper motor, for example.

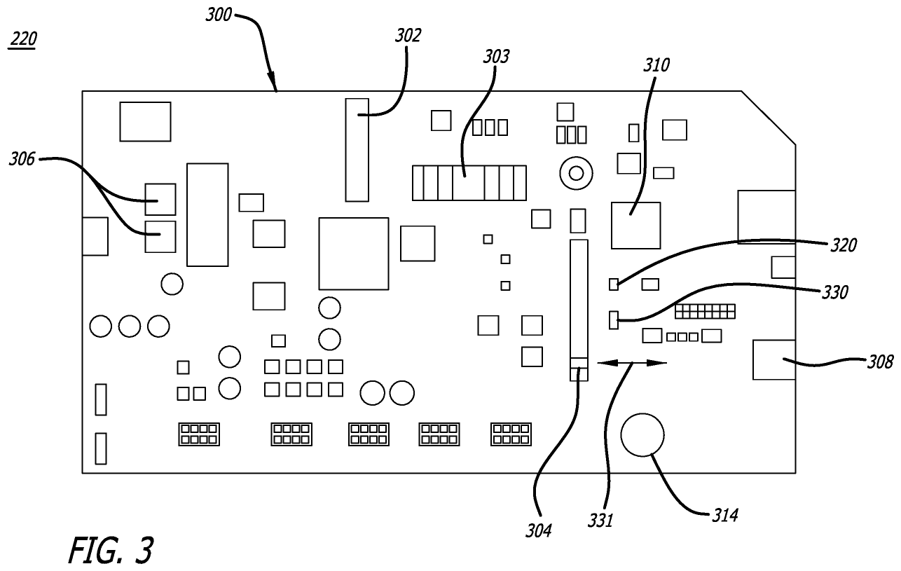

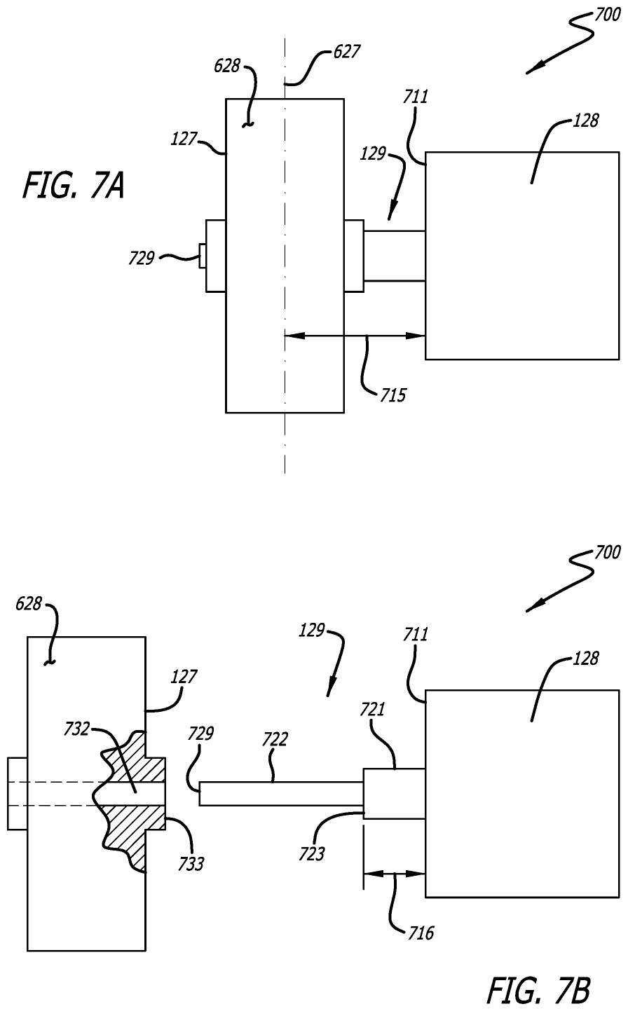

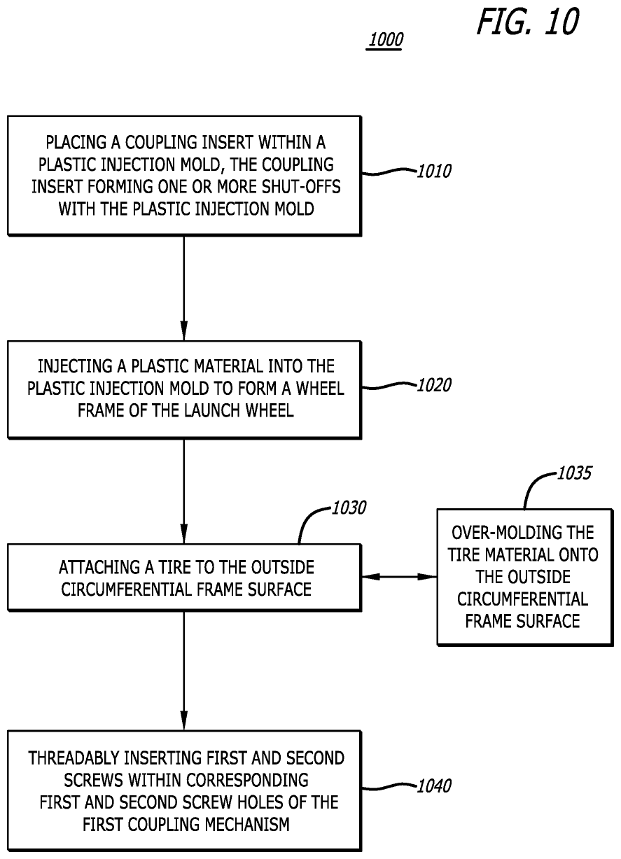

FIG. 3 illustrates a top view of the control unit 220. The control unit 220, having a control circuit, can include various features that can be used to control the ball-throwing machine 100 including the ball-delivery device 120. The control unit 220 includes a circuit card assembly (CCA) 300 having electronic circuitry that includes inter alia a power connector 302, an interface module connector 303, a daughter board connector 304, launch motor drivers 306, a wireless module (e.g., Bluetooth) 308, and a processor 310. Memory 312 (e.g., a non-transitory computer-readable medium) includes program instructions stored thereon for controlling the various electrical features of the ball-throwing machine 100, such as the launch motors 128 of the ball-delivery device 120 and other actuators as described above. The power connector 302 provides for a wired connection to the power source 222, the interface module connector 303 provides for a wired connection to the interface module 1000 (see FIG. 10), and the daughter board connector 304 provides for a wired connection to a daughter board 350 which is further described below with reference to FIG. 7. The launch motor drivers 306 provide electrical power to the launch motors 128 as defined by electrical signals from the processor 310. The CCA 300 further includes an audio notification device 314 (e.g., a buzzer or a speaker) configured to provide various audible notifications or alerts to the user as defined by the logic.

The wireless module 308 is configured to enable communication of the ball-throwing machine 100 with at least the remote controller 80. For example, the wireless module 308 enables the ball-throwing machine 100 to receive operating commands from the remote controller 80 and to transmit operational data to the remote controller 80.

In the illustrated embodiment, the control unit 220 includes one or more operational sensors configured to monitor operation of the ball-throwing machine 100, such as detecting anomalous operating conditions, for example. The control unit 220 may include a microphone 320 electrically coupled with the CCA 300 so that the logic when executed by the processor 310 may analyze sound data and determine therefrom if the ball-throwing machine 100 is operating normally, i.e., the logic may determine from the sound data the ball-throwing machine 100 is operating abnormally or anomalously in any number of ways. The microphone 320 is directly attached to the CCA 300 to enhance a reliability and reduce the cost of the ball-throwing machine 100 by eliminating wires, connectors, and specific microphone mounting components. During operation, the ball-throwing machine 100 generates various noises, i.e., sound data, associated with normal operation, and the ball-throwing machine 100 may also generate different sound data associated with abnormal operation.

By way of one example, during normal operation, the motors 128 may define an expected sound data (e.g., a hum) as they rotate the launch wheels 127 at specifically defined speeds (RPM). In an instance where one of the motors 128 has a defect, such as worn out motor bearing, for example, the motors 128 may generate anomalous sound data, i.e. a sound data that is different from the expected sound data. In such as instance, the microphone 320 may pick up (i.e., hear) the anomalous sound data and determine therefrom that the one of the motors 128 is not operating properly.

By way of another example, the ball stop 210 may generate a noise when it transitions from (i) a first state preventing a ball 90 from traveling down the ball-delivery ramp 122 to the ball-delivery device 120 to (ii) a second state allowing a ball 90 to travel down the ball-delivery ramp 122 to the ball-delivery device 120. Coincident with a logic command to transition the ball stop 210 from the first state to the second state, the logic may look for an expected sound signature (as may be stored in memory) associated with normal transitioning from the first state to the second state. If the expected sound signature is not detected, the logic may determine that the ball stop 210 did not transition from the first state to the second state. In the illustrated embodiment, the microphone 320 may be located in close proximity to the ball stop 210, such as directly beneath ball stop 210 so that the microphone 320 may obtain an accurate sound data from the ball stop 210. Furthermore, the ball stop 210 may be mounted to the housing 102 such that the housing 102 acts as a sound board to generate the sound signature.

In a similar fashion, coincident with a logic command to transition the ball stop 210 from the first state to the second state thereby allowing the ball 90 to travel down the launch ramp 122 to the ball-delivery device 120, the logic may look for an expected sound signature associated with the launching of the ball 90. If the expected sound signature is not detected, the logic may determine that the ball 90 was not launched and that the launch as abnormal.

The control unit 220 may include, alternatively or in addition to the microphone 320, an accelerometer 330 electrically coupled with the CCA 300 so that the logic when executed by the processor 310 may analyze vibration data (or more broadly motion data) of the base frame member 216 and determine therefrom if the ball-throwing machine 100 is operating normally, i.e., the logic may determine from the vibration data if the ball-throwing machine 100 is operating abnormally in any number of ways. Similar to the microphone 320, the accelerometer 330 is directly attached to the CCA 300 to enhance a reliability and reduce the cost of the ball-throwing machine 100 by eliminating wires, connectors, and specific accelerometer mounting components. Furthermore, the CCA 300 is directly attached to the base frame member 216 so that the accelerometer 330 may obtain an accurate reading of motion/vibration of the base frame member 216. During normal operation, the operation of the ball-throwing machine 100 may cause the base frame member 216 to move in various expected ways, where such movement causes vibration data associated with normal operation, and the accelerometer 330 may detect or determine vibration data. In an instance of abnormal operation, the ball-throwing machine 100 may cause the base frame member 216 to move in ways associated with abnormal operation different from normal operation. Accordingly, the accelerometer 330 may be configured to detect a difference in vibration or motion of the base frame member 216 generated by the ball-throwing machine 100 between normal operation and abnormal operation.

By way of one example, during normal operation, the launch wheels 127 may define an expected vibration data as they rotate at specifically defined speeds (RPM). In some instances, the launch wheels 127 may wear out causing an imbalance of the launch wheels 127. As such, the imbalance may cause a difference (e.g., increase) in vibration of the base frame member 216 when the launch wheels 127 are rotated. Accordingly, the accelerometer 330 may detect vibration data that is different from an expected vibration signature. In response, the logic may determine that at least one of the launch wheels 127 is out of balance.

By way of another example, the base frame member 216 may move or vibrate in response to the launching of the ball 90, i.e., the base frame member 216 along with the ball-throwing machine 100 as a whole may kick or lurch in the rearward direction when the launch wheels 127 impart a speed to the ball 90. As such, coincident with each launch of a ball 90, the logic may look for expected vibration data associated with normal launch characteristics. If the detected vibration data is different from the expected vibration data (e.g., a vibration signature stored in memory), the logic may determine that the ball 90 was not launched as intended, e.g., not launched or launched abnormally. There are several potential causes for an abnormal ball launch, such as a wrong ball size, a deflated ball, a worn out ball, a ball having a slippery or wet surface, or worn out launch wheels, for example. In some embodiments, the accelerometer 330 may include a sensing orientation as indicated by the arrow 331. In such an embodiment, accelerometer 330 may be oriented so that the sensing orientation 331 is aligned with a front/rear direction of the ball-throwing machine 100 as shown in FIG. 3.

In a similar fashion as described above, the microphone 320 and/or the accelerometer 330 may be used to monitor operation of the launch angle actuator 225 and/or the lateral direction actuator 235. In other words, the microphone 320 and/or the accelerometer 330 may be deployed to determine if, upon an actuation command, one or both of the launch angle actuator 225 or the lateral direction actuator 235 normally operate, abnormally operate, or fail to operate.

It will be understood that the ball-delivery device 120 can function in many different ways, including ways different from those described herein. For example, rather than including a launch angle actuator 225 or a lateral angle actuator 235, the ball-delivery device 120 can be moved or positioned manually. Further, although described as being primarily used for pitching soccer balls, the ball-delivery device 120 can also be adapted to pitch other types of balls, such as baseballs, softballs, tennis balls, racquet balls, squash balls, cricket balls, lacrosse balls, volleyballs, and the like.

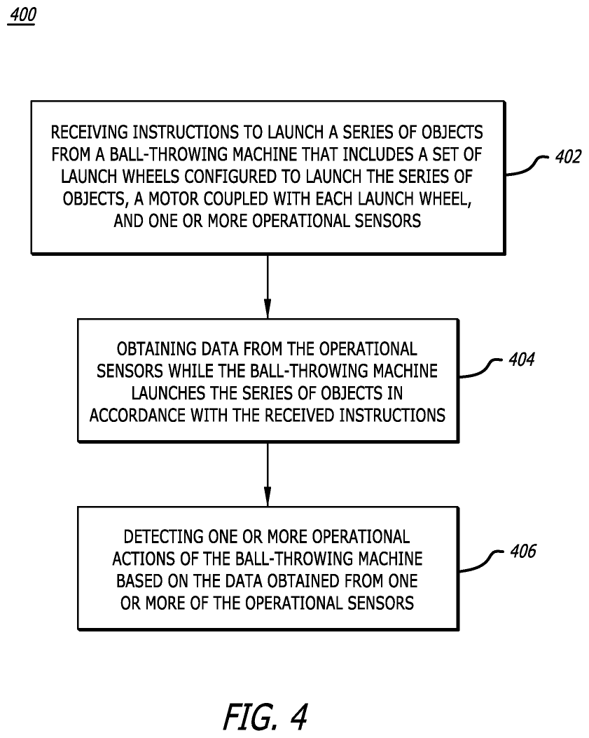

FIG. 4 is a block diagram of a computerized method 400 that, according to some embodiments, includes all or any subset of the following actions, operations, or processes. Each block illustrated in FIG. 4 represents an operation of the method 400 performed by the ball-throwing machine disclosed herein, and typically as a result of execution of logic of the ball-throwing machine. The method 400 may include receiving instructions to launch a series of objects from a ball-throwing machine that includes a set of launch wheels configured to launch the series of objects, a motor coupled with each launch wheel, and one or more operational sensors (block 402). In some embodiments of the method 400, launching the series of objects includes rotating the set of launch wheels to cause delivery of the series of objects to a player, where the series of objects may include one or more balls. In some embodiments of the method 400, the one or more operational sensors include at least one of an accelerometer or a microphone. The method 400 may further include obtaining data from the operational sensors while the ball-throwing machine launches the series of objects in accordance with the received instructions (block 404). The method 400 may further include detecting one or more operational actions of the ball-throwing machine based on the data obtained from one or more of the operational sensors (block 406). In some embodiments, the computerized method 400 further includes (i) analyzing the data pertaining to the operation of the ball-throwing machine and (ii) detecting that the launch of the first object was anomalous through comparison of the data pertaining to the operation of the object-throwing apparatus to a data signature stored in memory of the ball-throwing machine, where the data signature represents an expected set of data corresponding to the launch of the series of objects. In some embodiments, the method 400 further includes (i) analyzing the data pertaining to the operation of the ball-throwing machine, where the data pertaining to the operation of the ball-throwing machine includes at least one of vibration data or sound data; and (ii) detecting that the ball-throwing machine is performing anomalously through comparison of the data pertaining to the operation of the ball-throwing machine to a data signature representing an expected vibration data or sound data.

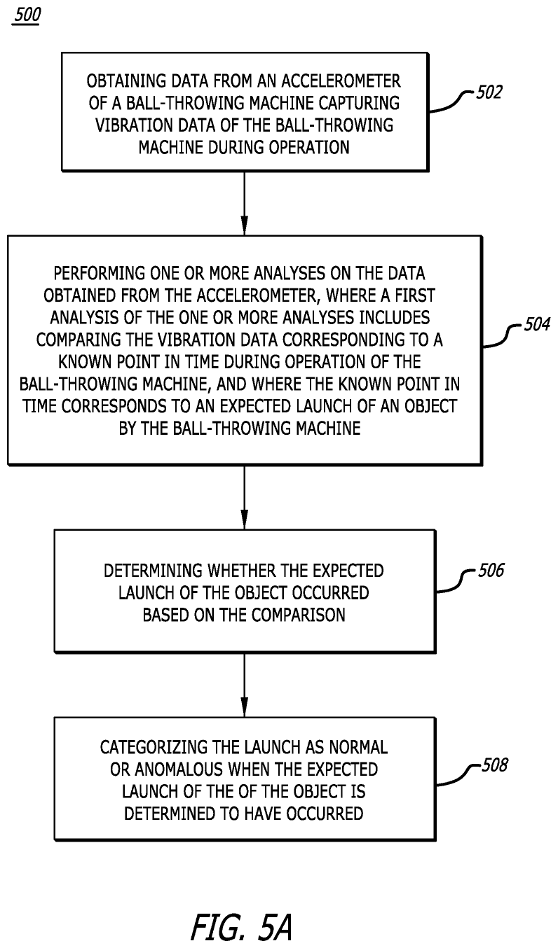

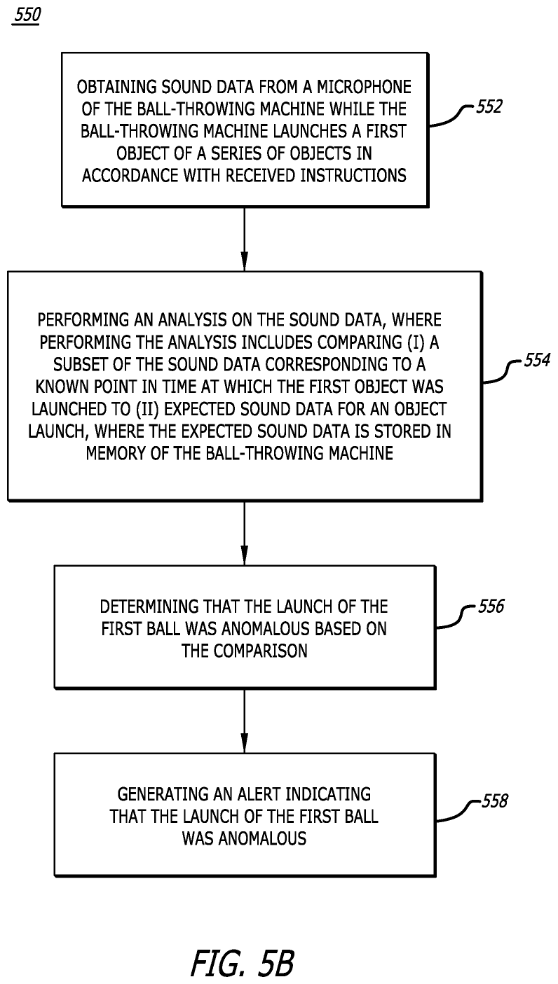

FIG. 5A is a block diagram of a computerized method 500 that, according to some embodiments, includes all or any subset of the following actions, operations, or processes. Each block illustrated in FIG. 5 represents an operation of the method 500 performed by a ball-throwing machine disclosed herein, and typically as a result of execution of one or more logic modules disclosed of the ball-throwing machine. The method 500 may include obtaining data from an accelerometer of a ball-throwing machine capturing vibration data of the ball-throwing machine during operation (block 502). The method 500 may further include performing one or more analyses on the data obtained from the accelerometer, where a first analysis of the one or more analyses includes comparing the vibration data corresponding to a known point in time during operation of the ball-throwing machine, and where the known point in time corresponds to an expected launch of an object by the ball-throwing machine (block 504). The method 500 may further include determining whether the expected launch of the object occurred based on the comparison (block 506). The method 500 may further include categorizing the launch as normal or anomalous when the expected launch of the of the object is determined to have occurred (block 508).

FIG. 5B is a block diagram of a computerized method 550 that, according to some embodiments, includes all or any subset of the following actions, operations, or processes. Each block illustrated in FIG. 5 represents an operation of the method 550 performed by a ball-throwing machine disclosed herein, and typically as a result of execution of one or more logic modules disclosed of the ball-throwing machine. The method 550 may include obtaining sound data from a microphone of the ball-throwing machine while the ball-throwing machine launches a first object of a series of objects in accordance with received instructions (block 552). The method 550 may further include performing an analysis on the sound data, where performing the analysis includes comparing (i) a subset of the sound data corresponding to a known point in time at which the first object was launched to (ii) expected sound data for an object launch, where the expected sound data is stored in memory of the ball-throwing machine (block 554). The method 550 may further include determining that the launch of the first ball was anomalous based on the comparison (block 556) and generating an alert indicating that the launch of the first ball was anomalous (block 558). In some embodiments of the method 550, the alert is recorded in a data log. In some embodiments of the computerized method 550, a control circuit of the ball-throwing machine is configured to receive instructions to launch the series of objects, where the instructions indicate a number of objects to be launched and at least a speed or a trajectory for each of the objects to be launched.

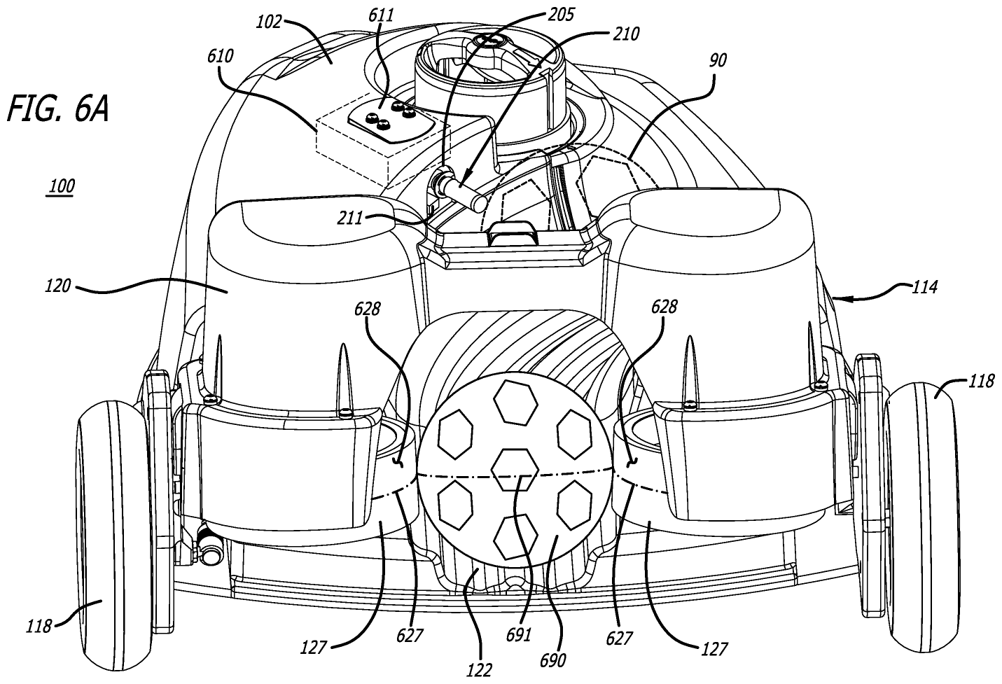

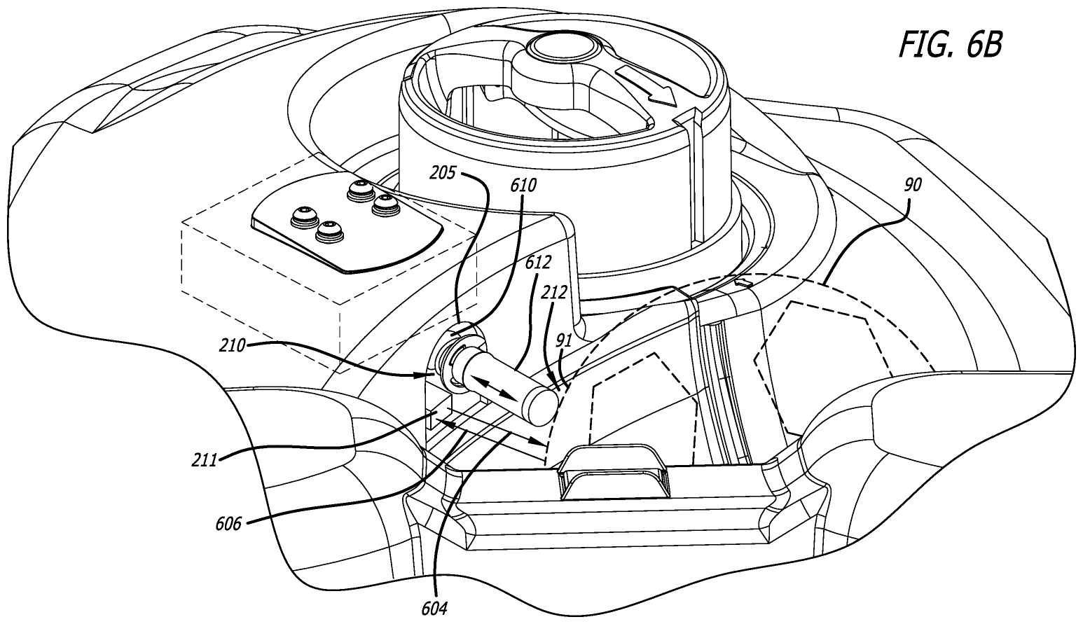

FIG. 6A is a front view illustration of the ball-throwing machine 100 with the hopper 126 removed. Shown is the ball-delivery ramp 122 positioned between the launch wheels 127 of the ball-delivery device 120. Also shown in phantom lines is the ball 90 located in the ball staging area 212 (see FIG. 2). As discussed above, the ball-throwing machine 100 includes the ball stop 210 that prevents the ball 90 from exiting the ball staging area 212 and the ball sensor 211 that detects the presence of the ball 90 within the staging area 212. The ball stop 210 include a solenoid 610 shown hidden beneath the housing 102. The solenoid 610 is attached to an underside of the housing 102 via the solenoid mount 611.

A ball 690 which is one of the balls 90, is shown within the ball-delivery ramp 122, where the ball 690 is in contact with each of the launch wheels 127 during a launching operation. The launch ramp 122 and launch wheels 127 are positioned with respect to each other such that a centerline 691 of the ball 690 is in substantial alignment with a centerline 627 of each launch wheel 127, where the centerline 627 is a centerline of a circumferential surface 627A of the launch wheel 127. An off-center alignment of the centerline 691 of the ball 690 with a centerline 627 of each wheel 127 may cause (1) the ball 690 to be launched in an unintended direction and/or (2) one or both wheels 127 to damage the ball 690. As such, it is advantageous to maintain the substantial alignment of the centerline 627 of each wheel 127 with the centerline 691 of the ball 690.

FIG. 6B is a detailed view of a portion of the ball-throwing machine 100 showing the ball stop 210 and the ball sensor 211 disposed within the opening 205. The ball stop 210 further includes a protrusion 612 operatively coupled with the solenoid 610 so that the protrusion 612 may extend through the opening 205. In accordance with actuation of the solenoid 610, the protrusion 612 is selectively positionable between an extended position and a retracted position. In the extended position, the protrusion 612 protrudes from the opening 205 to engage the ball 90 so as to retain the ball 90 within the staging area 212. In the retracted position, the protrusion 612 disengages the ball 90 to allow the ball 90 to exit the staging area 212 and travel down the ball-delivery ramp 122 to the ball-delivery device 120 for launching. In the illustrated embodiment, the protrusion 612 is biased towards the extended position, such that when the solenoid 610 is deactivated (i.e., de-energized) the ball 90 is retained within the staging area 212 and prevented from being launched. One advantage of biasing the protrusion 612 toward the extended position is that balls 90 can be stored in the staging area 212 and the hopper 126 when the ball-throwing machine 100 is not in use.

As discussed above, the ball sensor 211 detects the presence and/or absence of a ball 90 within the staging area 212. In the illustrated embodiment, the ball sensor 211 is coupled with the underside of the housing 102. In some embodiments, the ball sensor 211 may be directly attached to the solenoid 610 which is attached to the underside of the housing 102. The ball sensor 211 may be any type of sensor capable of detecting the presence of the ball 90, such as a ball activated switch, a proximity sensor, a capacitive sensor, an inductive sensor, or an optical sensor, for example. In the illustrated embodiment, the ball sensor 211 is an optical sensor configured to project an emitted light signal 606 through the opening 205 and into the staging area 212. The ball sensor 211 is further configured and detect a reflected light signal 604, i.e., a reflection of the emitted light signal 606 off of a surface 91 of the ball 90 when the ball 90 is disposed within the staging area 212. As the ball 90 includes different colors, e.g., black and white, and as the surface of the ball 90 may include seams that may affect reflection, the emitted light signal 606 may include a defined wavelength spectrum for optimal operation and/or reliability of ball detection. In the illustrated embodiment, the ball sensor 211 includes a laser configured to project the emitted light signal 606 having a wavelength within the red spectrum to optimize operation and/or reliability of ball detection.

FIG. 7A illustrates a motor-wheel assembly 700 in an assembled state. The motor-wheel assembly 700 includes the launch wheel 127 coupled with the motor 128. The launch wheel 127 is attached to that shaft 129 of the motor 128 so that the launch wheel 127 and the shaft 129 co-rotate. The launch wheel 127 is attached to the shaft 129 so as to maintain a distance 715 between the centerline 627 of the launch wheel 127 and a mounting surface 711 of the motor 128.

FIG. 7B illustrates a motor-wheel assembly 700 in an exploded state where the launch wheel 127 is separated from the motor 128, i.e., where the shaft 129 is removed from a center hole 732 of the launch wheel 127. The shaft 129 includes a large diameter portion 721 extending away from the mounting surface 711 and a small diameter portion 722 extending away from the large diameter portion 721. The larger diameter portion 721 includes a shoulder surface 723 disposed at the junction between the larger diameter portion 721 portion and the small diameter portion 722. The shoulder surface 723 is configured to butt up against a shoulder contact surface 733 of the launch wheel 127 when the motor-wheel assembly 700 is disposed in the assembled state of FIG. 7A. The shoulder surface 723 is disposed a distance 716 from the mounting surface 711 such that when the motor-wheel assembly 700 is disposed in the assembled state with the shoulder surface 723 butted up against a shoulder contact surface 733, the distance 715 between the centerline 627 of the launch wheel 127 and a mounting surface 711 of the motor 128 is established. When the centerline 627 of the launch wheel 127 and a mounting surface 711 of the motor 128 are established as discussed above, the centerline 627 of the launch wheel 127 is in substantial alignment with the centerline 691 of the ball 690 (see FIG. 6A).

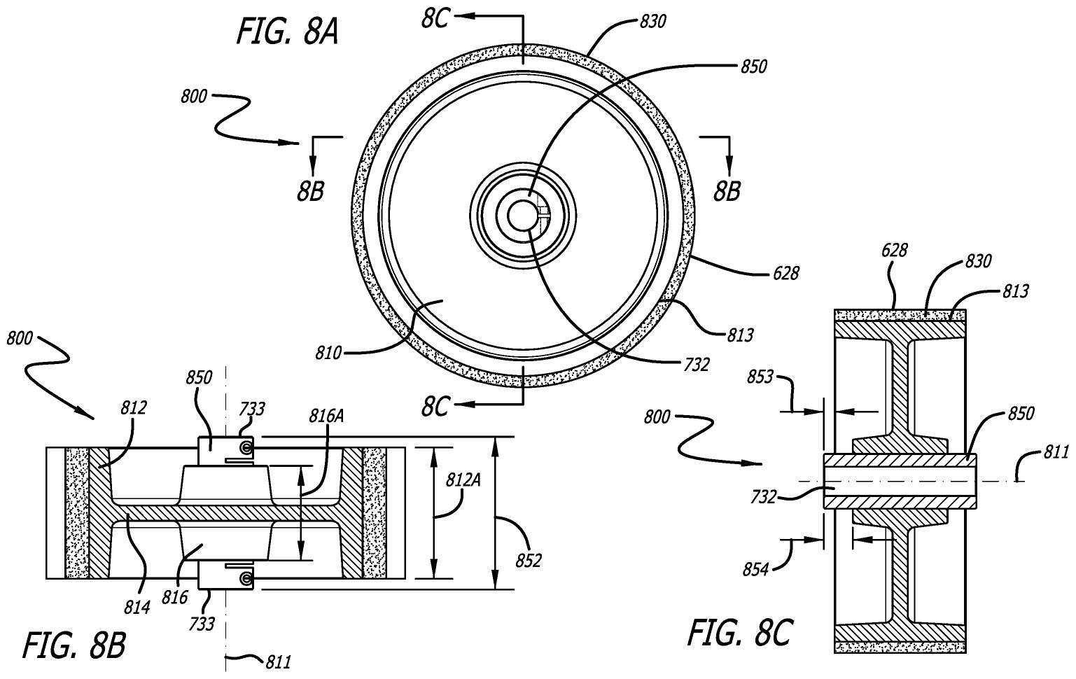

FIGS. 8A-8C illustrate various views of a wheel assembly 800. The launch wheel 127 is composed of the wheel assembly 800. FIG. 8A is an end view of the wheel assembly 800. FIG. 8B is a cross-sectional side view of the wheel assembly 800 cut along sectioning lines 8B-8B and FIG. 8C is a cross-sectional side view of the wheel assembly 800 cut along sectioning lines 8C-8C. The description that follows refers each of the FIGS. 8A-8C.

The wheel assembly 800 includes a wheel frame 810 and a coupling insert 850 coupled with the wheel frame 810 such that the coupling insert 850 is coincident with a central axis 811 of the wheel frame 810. The wheel frame 810 includes a circumferential wall 812, a hub 816, and a central wall 814 coupled between the circumferential wall 812 and the hub 816. The circumferential wall 812, the central wall 814 and the hub 816 are centrally located about the central axis 811. The wheel frame 810 may formed a plastic material, such as a thermoplastic or a thermoset material. In the illustrated embodiment, the wheel frame 810 is formed of a glass-filled nylon material. The circumferential wall 812, the central wall 814, and the hub 816 are integrally formed as a single unit. The coupling insert 850 may be formed of an aluminum material, such as a 6061-T6 aluminum alloy, for example. In other embodiments, the coupling insert 850 may be formed of a carbon steel or stainless steel. The wheel assembly 800 may be symmetrical about an axis perpendicular the axis 811 such that upon wearing of the launch wheel 127, the wheel assembly 800 and the launch wheel 127 may be flipped about the axis perpendicular the axis 811. As a result, the launch wheel 127 contacts the balls 90 with an unworn (or slightly worn circumferential surface 628). Thus, the circumferential surface 628 of the launch wheel 127 may wear evenly by operating the ball-throwing machine 100 with the launch wheel 127 and the wheel assembly 800 disposed in a first configuration and flipping the launch wheel 127 and the wheel assembly 800 about an axis perpendicular to the axis 811 to a second configuration. The symmetrical nature of the wheel assembly 800 and the launch wheel 127 enables an individual to easily flip the launch wheels 127 and avoid wheel replacement following wearing of a first side of a launch wheel 127.

The wheel includes a tire 830 coupled with the circumferential wall 812 along an outside surface 813 of the circumferential wall 812 such that the tire 830 defines the circumferential surface 628 of the launch wheel 127. The tire 830 maybe formed of an elastomeric material such as a rubber, a silicone, or a polyurethane material, for example. The tire 830 may be attached to the circumferential wall 812 during a forming process of the tire 830, such as a molding or casting process. In some embodiments, the tire 830 may be initially formed having a cylindrical or tubular shape and once formed, the tire 830 may be attached to the circumferential wall 812 via an adhesive. The tire 830 is configured to engage the ball 690 during the launch process and as such, the tire material is configured to minimize sliding motion of the tire 830 with respect to the ball 690. In some embodiments, the tire 830 may wear during use as a result of repeatedly launching the balls 90. Accordingly, the wear may require the launch wheel 127 (i.e., either of the two launch wheels 127) to be replaced one or more times during the life of the ball-throwing machine 100. Therefore, the launch wheel 127 may be configured for replacement as part of a repair or maintenance process. In some instances, it may be advantageous for the user to replace the launch wheel 127. As such, the launch wheel 127 may be configured for easy replacement by the user.

The coupling insert 850 extends through the hub 816 and the coupling insert 850 is coupled with the hub 816 such that the coupling insert 850 is longitudinally and rotationally fixed with respect to the hub 815. The circumferential wall 812 defines a wheel width 812A and the coupling insert 850 defines an insert length 852. In the illustrated embodiment, insert length 852 is greater than the wheel width 812A. In some embodiments, the coupling insert 850 is centrally disposed with respect to wheel width 812A such that the coupling insert 850 extends beyond each of the opposite sides of the circumferential wall 812 an equal distance. The symmetrical placement of the coupling insert 850 with respect the circumferential wall 812 or the wheel frame 810 may be advantageous because the launch wheel 127 may be coupled with the motor 128 in either orientation. In other words, either end of the coupling insert 850 may define the shoulder contact surface 733.

The hub 816 defines a hub length 816A and the coupling insert 850 may be centrally disposed with respect to hub length 816A such that the coupling insert 850 extends beyond each of the opposite ends of the hub 816 an equal distance 854.

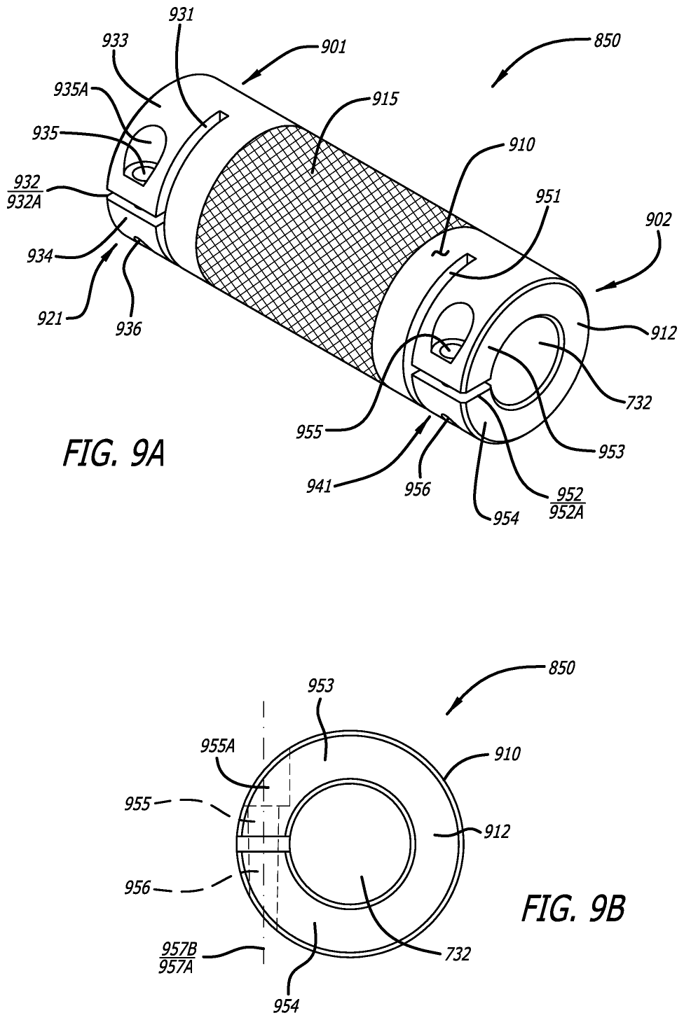

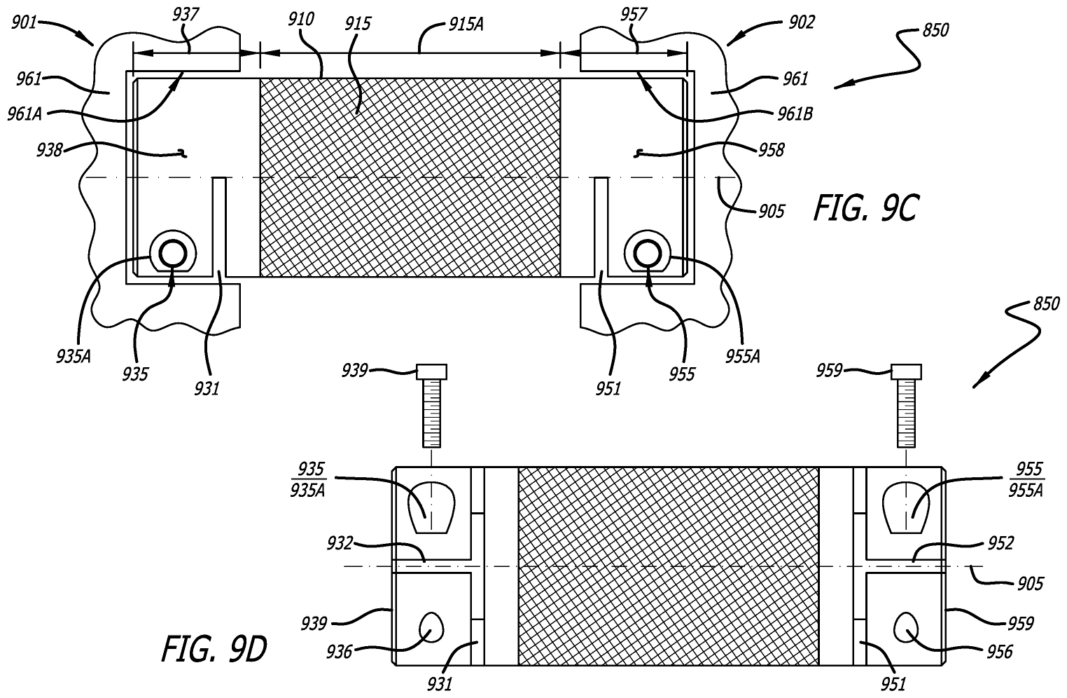

FIGS. 9A-9D illustrate various detailed views of the coupling insert 850. FIG. 9A is a perspective view of the coupling insert 850. FIG. 9B is a right end view of the coupling insert 850. FIG. 9C is a top view of the coupling insert 850 and FIG. 9D is a front view of the coupling insert 850. With reference to FIG. 9A, the coupling insert 850 takes the form of a hollow cylinder defining the center hole 732, a circumferential outside surface 910, a cylindrical wall 912, a left end 901, and a right end 902. A portion of the circumferential outside surface 910 includes a knurling 915 configured to ensure a secure attachment between the coupling insert 850 and wheel frame 810 during the forming process (e.g., over-molding process). As an alternative or in addition to the knurling 915, the circumferential outside surface 910 may include other features, such as depressions, groves, ribs, ridges, protrusions, and the like.

The coupling insert 850 includes first and second clamping mechanisms 921, 941 at each of the left and right ends 901, 902. The first clamping mechanism 921 includes a first lateral slit 931 disposed inward of the left end 901, where the first lateral slit 931 extends through the cylindrical wall 912 from the circumferential outside surface 910 to the center hole 732. The first clamping mechanism 921 further includes a first longitudinal slit 932 extending between the left end 901 and the first lateral slit 931, where the first longitudinal slit 932 also extends through the cylindrical wall 912 from the circumferential outside surface 910 to the center hole 732. The first lateral slit 931 and the first longitudinal slit 932 define first and second of deflectable arms 933, 934 disposed opposite each other, where the first and second deflectable arms 933, 934 may be symmetrical with respect to each other. The first longitudinal slit 932 defines a first gap 932A between opposing ends of first and second deflectable arms 933, 934. The first and second deflectable arms 933, 934 are configured to elastically deflect toward each other, thereby decreasing the first gap 932A and decreasing a diameter of the center hole 732 at the left end 901.

The first deflectable arm 933 includes a first screw hole 935, having a first counter bore 935A, extending through the first deflectable arm 933 between the circumferential outside surface 910 and the first longitudinal slit 932, where the first screw hole 935 is configured to slidably receive a first screw 939 (see FIG. 9D) therethrough. The second deflectable arm 934 includes a first threaded portion 936 of the first screw hole 935 extending through the second deflectable arm 934 between the circumferential outside surface 910 and the first longitudinal slit 932, where the first threaded portion 936 is configured threadably receive the screw 939 therethrough. The first screw hole 935, including the first threaded portion 936, is configured to cause and release the deflection of the first and second deflectable arms 933, 934 upon tightening and loosening of the first screw 939, respectively.

Similarly, the second clamping mechanism 941 includes a second lateral slit 951 disposed inward of the right end 902, where the second lateral slit 951 extends through the cylindrical wall 912 from the circumferential outside surface 910 to the center hole 732. The second clamping mechanism 941 also includes a second longitudinal slit 952 extending between the right end 902 and the second lateral slit 951, where the second longitudinal slit 952 also extends through the cylindrical wall 912 from the circumferential outside surface 910 to the center hole 732. The second lateral slit 951 and the second longitudinal slit 952 define third and fourth deflectable arms 953, 954 disposed opposite each other, where the third and fourth deflectable arms 953, 954 may be symmetrical with respect to each other. The second longitudinal slit 952 defines a second gap 952A between opposing ends of the third and fourth deflectable arms 953, 954. The third and fourth deflectable arms 953, 954 are configured to elastically deflect toward each other, thereby decreasing the second gap 952A and decreasing a diameter of the center hole 732 at the right end 902.

The third deflectable arm 953 includes a second screw hole 955, having a second counter bore 955A, extending through the third deflectable arm 953 between the circumferential outside surface 910 and the second longitudinal slit 952, where the second screw hole 955 is configured to slidably receive a second screw 959 (see FIG. 9D) therethrough. The fourth deflectable arm 954 includes a second threaded portion 956 of the second screw hole 955 extending through the forth deflectable arm 954 between the circumferential outside surface 910 and the second longitudinal slit 952, where the second threaded portion 956 is configured to threadably receive the second screw 959 therethrough. The second screw hole 955 and the second threaded portion 956 are configured to cause and release the deflection of the third and fourth deflectable arms 953, 954 upon tightening and loosening of the second screw 959, respectively. In some embodiments, the second clamping mechanism 941 may omitted from the coupling insert 850.

FIG. 9B further illustrates the second screw hole 955 extending through the third deflectable arm 953 and the second threaded portion 956 extending through the fourth deflectable arm 954 along a second chord 957B, where the second chord 957B extends through the coupling insert 850 (i.e., through the hollow cylinder). A first chord 957A is shown behind the second chord 957B, where the first screw hole 935 extending through the first deflectable arm 933 and the first threaded portion 936 extending through the second deflectable arm 934 (see FIGS. 9A, 9C and 9D) extend along the first chord 957A. In some embodiments, the first chord 957A is oriented parallel with the second chord 957B. As shown, the central hole 732 is disposed congruent with the circumferential outside surface 910.

FIG. 9C further illustrates the knurling 915 disposed on the circumferential outside surface 910. The knurling 915 includes a length 915A which is less than the hub length 816A (see FIG. 8B). The knurling 915 is disposed inward of the left end 901 a distance 937 defining a first smooth portion 938 of the circumferential outside surface 910, such that the first smooth portion 938 extends inward of the left end 901 beyond the first lateral slit 931. The first smooth portion 938 may define a shut-off interface 961A with a first cylindrical opening of a plastic injection mold 961 used to form the wheel frame 810 via an injection molding process, where the shut-off interface 961A includes a clearance between the first smooth portion 938 and the plastic injection mold 961 sized to prevent flash from encroaching on or entering the first lateral slit 931 or other portions of the first clamping mechanism 921 during an injection molding (over-molding) process of the wheel frame 810. Similarly, the knurling 915 is disposed inward of the right end 902 a distance 957 defining a second smooth portion 958, such that the second smooth portion 958 extends inward of the right end 902 beyond the second lateral slit 951. In a similar fashion to the first smooth portion 938, the second smooth portion 958 may define a shut-off interface 961B with a second cylindrical opening of the plastic injection mold 961, where the shut-off interface 961B prevents flash from encroaching on or entering the second lateral slit 931, or other portions of the second clamping mechanism 941. In the illustrated embodiment, the knurling 915 defines an outside diameter of the coupling insert 850 that is greater than an outside diameter of the first and/or second smooth portions 938, 958. However, in other embodiments, the knurling 915 may define an outside diameter of the coupling insert 850 that is less than the outside diameter of the first and second smooth portions 938, 958.

In some embodiments, the first and second distances 937, 957 may be equal so that the knurling 915 is centrally located between left and right ends 901, 902 defining a longitudinal symmetry of the coupling insert 850. The longitudinal symmetry may allow for the coupling insert 850 to be disposed in either orientation during the forming process of the wheel frame 810.

In the illustrated embodiment, each of the first and second lateral slits 931, 951 extend inward from the outside circumferential surface 910 to a central longitudinal axis 905 of the coupling insert 850. In other embodiments, the either of the first and second lateral slits 931, 951 may extend short of or beyond the central longitudinal axis 905. More specifically, the first and second lateral slits 931, 951 define an arcuate length of the first, second, third and fourth inflatable arms 933, 934, 953, 954 that extends substantially 90 degrees around the central longitudinal axis 905.

FIG. 9D illustrates that the first and second longitudinal slits 932, 952 are disposed in alignment with the central longitudinal axis 905 such that in the front view of the coupling insert 850, the central longitudinal axis 905 bisects the first and second longitudinal slits 932, 952. As shown, the coupling insert 850 includes the first and second screws 939, 959 configured for insertion through the first and second screw holes 935, 955 including the first and second threaded portions 936, 956. The coupling insert 850 includes a left shoulder contact surface 939 at the left end 901 and a right shoulder contact surface 959 at the right end 902. As discussed above, the shoulder contact surface 733 may alternatively include the left shoulder contact surface 939 or the right shoulder contact surface 959.

During attachment of the wheel assembly 800 to the small diameter portion 722 of the shaft 129 of the motor 128, the user/installer may tighten the first screw 939 to draw the first and second deflectable arms 933, 934 toward each other, therapy securely clamping the coupling insert 850 to the small diameter portion 722 at the first end 901. Similarly, the user/installer may tighten the second screw 959 to draw the third and fourth deflectable arms 953, 954 toward each other, therapy securely clamping the coupling insert 850 to the small diameter portion 722 at the second end 902.

During removal of the wheel 800 from the small diameter portion 722 of the shaft 129 of the motor 128, the user/remover may loosen the first screw 939 to allow the first and second deflectable arms 933, 934 to self-deflect away from each other, therapy relieving the clamping effect of the coupling insert 850 to the small diameter portion 722 at the first end 901. Similarly, the user/installer may loosen the second screw 959 to allow the third and fourth deflectable arms 953, 954 to self-deflect away from each other, therapy relieving the clamping effect the coupling insert 850 to the small diameter portion 722 at the second end 902.

FIG. 10 illustrates a block diagram of a method 1000 of manufacturing the launch wheel for the object-throwing apparatus. The method 1000 may include all or any subset of the following steps, actions or processes, including placing a coupling insert within a plastic injection mold (block 1010) so that the wheel frame may be over-molded onto the coupling insert. The coupling insert includes a first smooth portion of the outside surface extending inward from the first end beyond the first coupling mechanism, where the first smooth portion is configured to define a first shut-off interface with the plastic injection mold. Placing a coupling insert within a plastic injection mold may include inserting the first end of the coupling insert into a first cylindrical opening of the injection mold where a diameter of the first cylindrical opening is sized to correspond with a diameter of the first smooth portion so that flash of the over-molding process is prevented from extending along the first smooth portion to the first coupling mechanism. Similarly, placing a coupling insert within a plastic injection mold may include inserting the second end of the coupling insert into a second cylindrical opening where a diameter of the second cylindrical opening is sized to correspond with a diameter of the second smooth portion so flash of the over-molding process is prevented from extending along the second smooth portion to the second coupling mechanism. The method 1000 may further include injecting a plastic material into the plastic injection mold to form the wheel frame of the launch wheel (block 1020), where the wheel frame includes an outside circumferential frame surface. The method 1000 may be further include attaching a tire to the outside circumferential frame surface (block 1030). In some embodiments, the tire includes an elastomeric material. In some embodiments of the method 1000, attaching the tire to the outside circumferential frame surface includes over-molding the tire material onto the outside circumferential frame surface (block 1035).

The manufacturing method 1000 may further include threadably inserting first and second screws within corresponding first and second screw holes of the first coupling mechanism (block 1040). The first screw hole may extend along a first chord of the coupling insert and the second screw hole may extend along a second chord of the coupling insert.

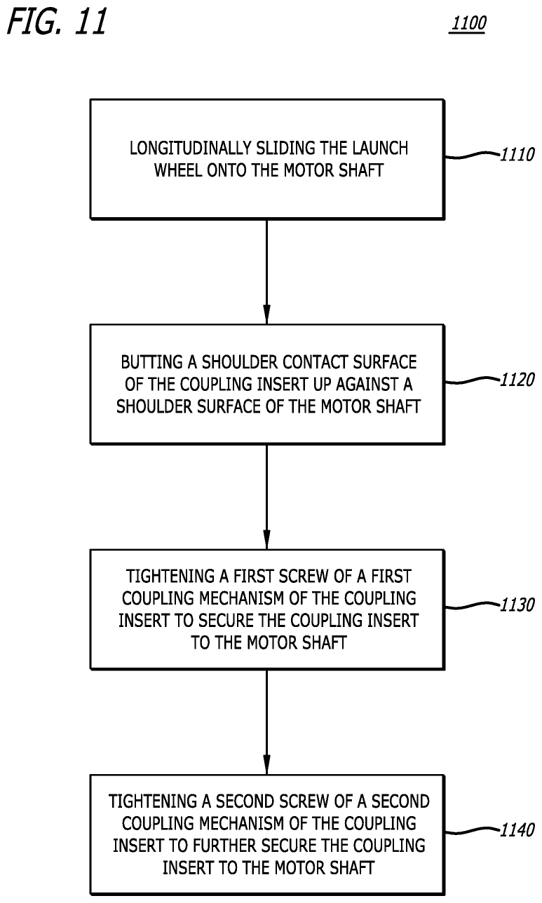

FIG. 11 illustrates a block diagram of a method 1100 of installing a launch wheel onto a motor shaft of an object-throwing. The method 1100 may include all or any subset of the following steps, actions or processes, including longitudinally sliding the launch wheel onto the motor shaft (block 1110), where the motor shaft is disposed within a center hole of a coupling insert of the launch wheel. The method 1100 may further include butting a shoulder contact surface of the coupling insert up against a shoulder surface of the motor shaft (block 1120), where butting the shoulder contact surface of the coupling insert up against the shoulder surface of the motor shaft defines a location of the launch wheel with respect to the ball-delivery ramp of the object-throwing apparatus. The method 1100 may further include tightening a first screw of a first coupling mechanism of the coupling insert to secure the coupling insert to the motor shaft (block 1130), where the first screw extends along a first chord of the coupling insert. In some embodiments of the method 1100, the first coupling mechanism may be disposed adjacent the shoulder contact surface.

In some embodiments, the method 1100 may further include tightening a second screw of a second coupling mechanism of the coupling insert to further secure the coupling insert to the motor shaft (block 1140), where the second screw extends along a second chord of the coupling insert. In some embodiments of the method 1100, the second coupling mechanism is disposed on a side of the launch wheel opposite the shoulder contact surface. In some embodiments of the method 1100, the coupling insert includes a smooth outside circumferential surface extending longitudinally inward of the shoulder contact surface beyond the first coupling mechanism, where the smooth outside circumferential surface is configured to define a shut-off interface with a plastic injection mold used to form a wheel frame of the launch wheel.

While some particular embodiments have been disclosed herein, and while the particular embodiments have been disclosed in some detail, it is not the intention for the particular embodiments to limit the scope of the concepts provided herein. Additional adaptations and/or modifications can appear to those of ordinary skill in the art, and, in broader aspects, these adaptations and/or modifications are encompassed as well. Accordingly, departures may be made from the particular embodiments disclosed herein without departing from the scope of the concepts provided herein.

What is claimed is:

1. A coupling insert for securing a launch wheel to an object-throwing apparatus, comprising:
a circumferential wall defining a cylinder having a center hole extending between a first end and a second end of the coupling insert, the center hole configured to receive a first portion of a motor shaft therethrough;
a coupling surface extending partially along an outside surface of the circumferential wall, the coupling surface configured to enable a secure attachment of a wheel frame of the launch wheel to the coupling insert during a forming process of the wheel frame; and
a first coupling mechanism disposed at the first end, the first coupling mechanism configured to secure the coupling insert to the first portion of the motor shaft, thereby ensuring co-rotation of the coupling insert and the motor shaft, wherein:
the first coupling mechanism includes a first screw disposed within a first screw hole,
the first screw hole extends laterally through the cylinder along a first chord of the cylinder, and
the first screw is configured to secure the coupling insert to the first portion of the motor shaft upon tightening of the first screw.

2. The coupling insert according to claim 1, wherein the first coupling mechanism further includes a shoulder contact surface configured to butt up against a shoulder of the motor shaft when the coupling insert is secured to the motor shaft,
wherein the shoulder is disposed between the first portion and a second portion of the motor shaft, and the second portion includes a diameter greater than a diameter of the first portion.

3. The coupling insert according to claim 1, wherein the coupling surface includes a knurling.

4. The coupling insert according to claim 1, wherein the coupling surface is centrally located between the first end and the second end.

5. The coupling insert according to claim 1, further including a first smooth portion extending along the outside surface of the circumferential wall between the first end and the coupling surface, wherein:
first smooth portion extends inward from the first end beyond the first coupling mechanism, and
the first smooth portion is configured to define a first shut-off interface with an injection mold used to form the wheel frame.

6. The coupling insert according to claim 1, wherein:
the first coupling mechanism further includes:
a first lateral slit extending radially inward through the circumferential wall; and
a first longitudinal slit extending through the circumferential wall between the first end and the first lateral slit,
the first lateral slit and the first longitudinal slit define a first deflectable arm and a second deflectable arm, and
the first screw hole extends through the first and second deflectable arms.

7. The coupling insert according to claim 1, further comprising a second coupling mechanism disposed at the second end, the second coupling mechanism configured to further secure the coupling insert to the first portion of the motor shaft, wherein:
the second coupling mechanism includes a second screw disposed within a second screw hole,
the second screw hole extends laterally through the cylinder along a second chord of the cylinder, and
the second screw is configured to secure the coupling insert to the first portion of the motor shaft upon tightening of the second screw.

8. The coupling insert according to claim 7, further comprising a second smooth portion extending along the outside surface of the circumferential wall between the second end and the coupling surface, wherein:
the second smooth portion extends inward from the second end beyond the second coupling mechanism, and
the second smooth portion is configured to define a second shut-off interface with the injection mold.

9. The coupling insert according to claim 7, wherein:
the second coupling mechanism further includes:
a second lateral slit extending radially inward through the circumferential wall; and
a second longitudinal slit extending through the circumferential wall between the second end and the second lateral slit,
the second lateral slit and the second longitudinal slit define a third deflectable arm and a fourth deflectable arm, and
the second screw hole extends through the third and fourth deflectable arms.

10. A launch wheel for an object-throwing apparatus, comprising:
a wheel frame;
a tire coupled with the wheel frame along an outside circumferential frame surface of the wheel frame; and
a coupling insert coupled with the wheel frame at center of the wheel frame, the coupling insert comprising:
a circumferential wall defining a cylinder having a center hole extending between a first end and a second end of the coupling insert, the center hole configured to receive a first portion of a motor shaft therethrough;
a coupling surface extending partially along an outside surface of the circumferential wall, the coupling surface configured to enable a secure attachment of the wheel frame to the coupling insert during a forming process of the wheel frame; and
a first coupling mechanism disposed at the first end, the first coupling mechanism configured to secure the coupling insert to the first portion of the motor shaft, thereby ensuring co-rotation of the coupling insert and the motor shaft, wherein:
the first coupling mechanism includes a first screw disposed within a first screw hole,
the first screw hole extends laterally through the cylinder along a first chord of the cylinder, and
the first screw is configured to secure the coupling insert to the first portion of the motor shaft upon tightening of the first screw.

11. The launch wheel according to claim 10, wherein the wheel frame is formed via a plastic injection molding process.

12. The launch wheel according to claim 10, wherein the first coupling mechanism further includes a shoulder contact surface configured to butt up against a shoulder of the motor shaft when the coupling insert is secured to the motor shaft,
wherein the shoulder is disposed between the first portion and a second portion of the motor shaft, and the second portion includes a diameter greater than a diameter of the first portion.

13. The launch wheel according to claim 10, wherein the coupling surface includes a knurling.

14. The launch wheel according to claim 10, wherein the coupling surface is centrally located between the first end and the second end.

15. The launch wheel according to claim 10, wherein the coupling insert further includes a first smooth portion extending along the outside surface of the circumferential wall between the first end and the coupling surface, wherein:
first smooth portion extends inward from the first end beyond the first coupling mechanism, and
the first smooth portion is configured to define a first shut-off interface with an injection mold used to form the wheel frame.

16. The launch wheel according to claim 10, wherein:
the first coupling mechanism further includes:
a first lateral slit extending radially inward through the circumferential wall; and
a first longitudinal slit extending through the circumferential wall between the first end and the first lateral slit,
the first lateral slit and the first longitudinal slit define a first deflectable arm and a second deflectable arm, and
the first screw hole extends through the first and second deflectable arms.

17. The launch wheel according to claim 10, wherein the coupling insert further includes a second coupling mechanism disposed at the second end, the second coupling mechanism configured to further secure the coupling insert to the first portion of the motor shaft, wherein:
the second coupling mechanism includes a second screw disposed within a second screw hole,
the second screw hole extends laterally through the cylinder along a second chord of the cylinder, and
the second screw is configured to secure the coupling insert to the first portion of the motor shaft upon tightening of the second screw.

18. The launch wheel according to claim 17, the coupling insert further includes a second smooth portion extending along the outside surface of the circumferential wall between the second end and the coupling surface; wherein:
the second smooth portion extends inward from the second end beyond the second coupling mechanism, and
the second smooth portion is configured to define a second shut-off interface with the injection mold.

19. The launch wheel according to claim 17, wherein:
the second coupling mechanism further includes:
a second lateral slit extending radially inward through the circumferential wall; and
a second longitudinal slit extending through the circumferential wall between the second end and the second lateral slit,
the second lateral slit and the second longitudinal slit define a third deflectable arm and a fourth deflectable arm, and
the second screw hole extends through the third and fourth deflectable arms.

20. A method of manufacturing a launch wheel for an object-throwing apparatus, comprising:
placing a coupling insert within a plastic injection mold, the coupling insert including:
a circumferential wall defining a cylinder having a center hole extending between a first end and a second end of the coupling insert;
a coupling surface of the including a knurling extending partially along an outside surface of the circumferential wall;
a first coupling mechanism disposed at the first end, the first coupling mechanism configured to secure the coupling insert to a motor shaft;
a first smooth portion of the outside surface extending inward from the first end beyond the first coupling mechanism, the first smooth portion configured to define a first shut-off interface with the plastic injection mold;
a second coupling mechanism disposed at the second end, the second coupling mechanism configured to further secure the coupling insert to the motor shaft; and
a second smooth portion of the outside surface extending inward from the second end beyond the second coupling mechanism, the second smooth portion configured to define a second shut-off interface with the plastic injection mold;
injecting a plastic material into the plastic injection mold to form a wheel frame of the launch wheel, the wheel frame including an outside circumferential frame surface; and
attaching a tire to the outside circumferential frame surface, the tire including an elastomeric material.

21. The method according to claim 20, wherein attaching the tire to the outside circumferential frame surface includes over-molding the elastomeric material onto the outside circumferential frame surface.

22. The method according to claim 20, further comprising:
threadably inserting a first screw within a first screw hole of the first coupling mechanism, wherein the first screw hole extends along a first chord of the coupling insert; and
threadably inserting a second screw within a second screw hole of the second coupling mechanism, wherein the second screw hole extends along a second chord of the coupling insert.

23. A method of installing a launch wheel onto a motor shaft of an object-throwing apparatus, comprising:
sliding the launch wheel onto the motor shaft, the motor shaft disposed within a center hole of a coupling insert of the launch wheel;
butting a shoulder contact surface of the coupling insert up against a shoulder surface of the motor shaft, thereby defining a location of the launch wheel with respect to a ball-delivery ramp of the object-throwing apparatus; and
tightening a first screw of a first coupling mechanism of the coupling insert to secure the coupling insert to the motor shaft, the first screw extending along a first chord of the coupling insert.

24. The method according to claim 23, wherein the first coupling mechanism is disposed adjacent the shoulder contact surface.

25. The method according to claim 23, further comprising:
tightening a second screw of a second coupling mechanism of the coupling insert to further secure the coupling insert to the motor shaft, the second screw extending along a second chord of the coupling insert.

26. The method according to claim 25, wherein the second coupling mechanism is disposed on a side of the launch wheel opposite the shoulder contact surface.

27. The method according to claim 23, wherein:
the coupling insert includes a smooth outside circumferential surface extending longitudinally inward of the shoulder contact surface beyond the first coupling mechanism, and
the smooth outside circumferential surface is configured to define a shut-off interface with a plastic injection mold used to form a wheel frame of the launch wheel.
